(19) United States
(12) Patent Application Publication
(10) Pub. No.: US 2020/0168096 A1
(43) Pub. Date: May 28, 2020

(54) ENVIRONMENTAL MONITORING OF AN EGO VEHICLE

(71) Applicant: ZF Friedrichshafen AG, Friedrichshafen (DE)

(72) Inventors: Lutz Eckstein, Aachen (DE); Jan Bavendiek, Roetgen (DE)

(73) Assignee: ZF Friedrichshafen AG, Friedrichshafen (DE)

(21) Appl. No.: 16/624,693

(22) PCT Filed: May 15, 2018
(86) PCT No.: PCT/EP2018/062454

§ 371 Date: Dec. 19, 2019

(30) Foreign Application Priority Data
Jun. 20, 2017 (DE) 10 2017 210 266.7

(51) Int. Cl. G08G 1/16; B60W 30/095; B60W 30/10; B60W 30/09

(52) U.S. Cl. CPC G08G 1/166; B60W 30/0956; B60K 2370/167; B60W 30/09; B60W 30/10

(57) ABSTRACT

A method for monitoring an environment of an ego vehicle may include the following: identifying and evaluating at least one object in the environment of the ego vehicle with a sensor system, where the evaluation is based on the relevance for the ego vehicle, and/or for its intended spatiotemporal trajectory, where, if the relevance exceeds an intervention threshold T2, an assistance system intervenes in the spatiotemporal trajectory of the ego vehicle, and/or the driver of the ego vehicle is issued a maneuvering suggestion in this regard, in order to prevent or mitigate a collision. The object, including its position in relation to the ego vehicle, may be depicted on a display device in the ego vehicle, The visual conspicuousness of the object on the display device may be at least enhanced when the relevance of the object exceeds a notification threshold T1.

### CROSS-REFERENCE TO RELATED APPLICATIONS

This application is a filing under 35 U.S.C. § 371 of International Patent Application PCT/EP2018/062454, filed May 15, 2018, and claiming priority to German Patent Application 10 2017 210 266.7, filed Jun. 20, 2017. All applications listed in this paragraph are hereby incorporated by reference in their entireties.

### TECHNICAL FIELD

The invention relates to a method for monitoring the environment of an ego vehicle and an assistance system for vehicles for mitigating risks in traffic, and an associated computer program product.

### BACKGROUND

Assistance systems for mitigating risks in street traffic are known, which record environment information by means of cameras and other sensors, and identify other vehicles therein. Identified vehicles are evaluated with regard to their relevance for the ego vehicle. If the relevance of a vehicle exceeds a threshold value, a warning is issued to the driver of the ego vehicle, and/or the assistance system actively intervenes in the driving dynamics of the ego vehicle.

US 2017/120 907 A1 discloses an example of such an assistance system that is specifically configured to warn the ego vehicle of a vehicle dangerously approaching from the rear, and to potentially take countermeasures, such as accelerating the ego vehicle, in order to avoid a collision.

### BRIEF DESCRIPTION OF THE DRAWINGS

Various exemplary embodiments and details are described in greater detail in reference to the figures described below. Therein:

FIG. 1 shows a schematic illustration of an exemplary embodiment of the method 100 according to the invention;

FIG. 2 shows various exemplary possibilities for modifying the visual conspicuousness 32a-32c in the depiction on the display device 5;

FIG. 3 shows an exemplary display on the display device 5 in a driving situation; and

FIG. 4 shows an exemplary assistance system 4 according to the invention.

### DETAILED DESCRIPTION

A method for monitoring the environment of an ego vehicle is developed in the framework of the invention. At least one object, and/or group of objects, is identified in the environment of the ego vehicle with this method by means of a sensor system, and evaluated with regard to its relevance to the ego vehicle, and/or for its intended spatiotemporal trajectory.

The term “ego vehicle” with regard to its conventional use in the field of autonomous driving is understood to be that vehicle, the environment of which is to be monitored, and the behavior of which is to be affected with the method, or the assistance system. The ego vehicle can be a motor vehicle, in particular, intended for street traffic, or it can be a boat.

The spatiotemporal trajectory of a vehicle is understood to be a trajectory that links locations that the vehicle passes with the respective times at which the vehicle is at these locations.

The relevance of an object is understood to be the effect of the object in particular on the safety of the ego vehicle. Such an effect may exist, for example, if there is the risk of a collision.

If the identified relevance exceeds an intervention threshold T2, at least one assistance system intervenes in the spatiotemporal trajectory of the ego vehicle, and/or the driver of the ego vehicle is issued a maneuvering suggestion in this regard, in order to prevent or mitigate a collision with the object, or an object in the group.

The assistance system can be an adaptive cruise control (ACC), or a system that monitors the blind spot of a rear view mirror.

The intervention can comprise avoidance, braking, and/or acceleration on the part of the ego vehicle, for example.

According to the invention, the object, including its position in relation to the ego vehicle, is indicated on a display device, wherein the visual conspicuousness of the object on the display device is at least enhanced when the relevance of the object, or the group of objects, exceeds a notification threshold T1, and wherein the notification threshold T1 is lower than the intervention threshold T2. In order to better detect the relative position of the identified object in relation to the ego vehicle, both the object as well as the ego vehicle are advantageously simultaneously depicted in the display device.

In this manner, it is possible for the driver of the ego vehicle to check the behavior of the assistance system for plausibility. In a conflict-less driving situation, those objects identified by the monitoring system are presented to the driver such that they demand only a minimum of attention. This enables the driver to at least determine that the environment monitoring has identified those objects that the driver also sees, which significantly increases the sense of safety in dealing with the assistance system: The functionality of the assistance system is always transparent to the driver, and displays itself not only in critical situations. This is even more the case when the perspective of the display on the display device is similar to the perspective in which the driver directly perceives the environment of the vehicle. For this reason, the object is advantageously depicted three dimensionally on the display device.

If there is a pending conflict with an object, the driver can anticipate how the situation will come to a head. The driver is no longer surprised when there is an abrupt intervention in the behavior of the vehicle, or the driver is warned of having to take immediate action. Consequential startled responses that could be dangerous are advantageously prevented as a result. Instead, because of the visualization, the driver can determine on his own, which reaction on the part of the assistance system is most appropriate, and compare this with the subsequent actual reaction by the assistance system.

The information ultimately processed by the assistance system in order to intervene in the spatiotemporal trajectory of the ego vehicle, or issue warnings, is not presented to the driver on a 1:1 basis, but instead is filtered and formatted such that the driver is only presented with the most important information, under the boundary conditions of a limited available attention while dealing with the problems of driving.

As a result, the method can also be used, for example, to train a neural network, or some other form of artificial intelligence for autonomous driving. By way of example, it can be tested by a human driver in a real driving situation in such a training, whether the artificial intelligence reacts in the expected manner with regard to the situation identified by the monitoring of the environment. The internal logic of the artificial intelligence adapts successively as a result of the feedback from the driver in the training phase, such that in a real autonomous driving mode, a safe reaction, complying with regulations, is initiated in every situation.

The method can be used not only in moving traffic, but also, e.g., to help in parking maneuvers. In this case, the object that is most visibly noticeable as being the object that the ego vehicle could bump into, is emphasized. This feedback is much more useful to the driver than the mere feedback from numerous parking aids with regard to the location where the ego vehicle threatens to bump into something. If, for example, a post is identified, and made noticeable, the driver can determine that there is a post in this location. The next time the driver parks there, he can carefully maneuver around it from the start.

If the visualized object is part of a group categorized as relevant to the ego vehicle, all of the objects in the group can be visualized with a uniform visual conspicuousness, or marked in some other manner as belonging together. Alternatively, or in combination therewith, it can be encoded in the depiction, for example, that the ego vehicle should first avoid a first object, and subsequently avoid a second object in the group.

In a particularly advantageous embodiment of the invention, the notification threshold T1 is measured such that the visual enhancement of the object takes place 0.3 seconds to 1 second before reaching the intervention threshold T2. A time period of at least 0.3 seconds ensures that the driver has the opportunity before the intervention, or maneuvering instructions, to identify the situation on his own, based on the visualized object. A time period of no more than one second is advantageous, because the attention of the driver is only demanded in those situations that do not automatically become more critical. The visual conspicuousness is therefore only enhanced when it is predominantly probable that the intervention threshold T2 will actually be subsequently reached, and the warning issued, or the intervention takes place.

In another particularly advantageous embodiment of the invention, the object is displayed on the display device as soon as it is identified in an environment outside the ego vehicle that corresponds to the depiction on the display device. The object thus does not first appear when it has been identified as particularly relevant, but instead is already visible, but with less visual conspicuousness. This increases the sense of safety in dealing with the assistance system and also simplifies trouble shooting. As a result, an unexpected reaction or the lack thereof by the assistance system can be attributed to the fact that an object in the field of view of the driver is missing in the depiction on the display device, or that an object has appeared erroneously at a location where there is no actual object.

The visual conspicuousness of the object is enhanced continuously or in steps on the display device as the relevance of the object, or group of objects, increases. In this manner, the driver can be kept informed with precisely the right amount of attention to the driving situation.

In a particularly advantageous embodiment of the invention, the visual conspicuousness of the object is modified in that the depiction of the object is abstracted in order to obtain a lower visual conspicuousness, and made more concrete in order to obtain a higher level of visual conspicuousness. The depiction of the object can be abstracted, e.g. in the form of a box or other simplified depiction, or made more concrete in a depiction that more strongly corresponds to the actual shape of the object. Arbitrary intermediate steps of the depiction can be obtained, e.g. through morphing, i.e. depicting the transitions between the individual intermediate steps in the sense of an image processing.

In another particularly advantageous embodiment of the invention, the object is depicted as an outline, wherein the transparency of a surface of the outline is increased to obtain a lower conspicuousness, and reduced to obtain a higher conspicuousness. This type of depiction also enables an arbitrary number of intermediate steps, with which different degrees of relevance can be depicted.

Alternatively or in combination therewith, the color in which the object is depicted can also be altered in order to modify the visual conspicuousness. Grey or pale shades, for example, can be used to obtain a lower visual conspicuousness. Red or other noticeable colors, which have a strong contrast to the background, can be used to obtain a higher visual conspicuousness. The colors that are used can be arranged, for example, in a color gradient scale between a first color with the lowest conspicuousness and a second color with the highest conspicuousness, in order to depict intermediate steps.

Depending on how many intermediate steps for the visual conspicuousness are available in the selected depiction, the relevance of the identified object can be adjusted with a higher or lower resolution. The objects can be classified, for example, in three classes comprising, e.g., “irrelevant,” “potentially relevant,” and “relevant.” Alternatively, it is also possible to depict the relevance over a continuous gradation.

In a particularly advantageous embodiment of the invention, the relevance of the object, or group of objects, is evaluated as higher when there is a higher probability that the spatiotemporal trajectory of the ego vehicle must be altered in order to avoid a collision with the object, or an object in the group of objects, or to reduce the risk of such a collision. As such, a stationary obstruction that the ego vehicle approaches, for example, is particularly relevant, because the collision will take place in any case, if the ego vehicle does not brake and/or drive around the obstacle. If the object is another vehicle, however, which is moving, whether or not both vehicles will arrive at the same place at the same time depends on the behavior of this vehicle, or the driver of this vehicle.

The probability can be determined, for example, based on the behavior that is to be expected from the observations by the sensor system. If, for example, the ego vehicle is on a main road and approaches a vehicle at an intersection where there is a “stop” or “yield” sign, the relevance of this vehicle can be based on the speed with which this vehicle approaches point where it is to yield the right of way. If this speed is not decreased in time, this can be regarded as an indication that the other vehicle is not going to yield right of way.

The probability can also depend, e.g. on the manner in which the other vehicle indicates in detail the right of way. It is therefore more probable at an intersection with a stoplight, for example, that a driver is more aware of the right of way than at an intersection with a “stop” or “yield” sign, because a qualified violation of a red light is associated with higher penalties than driving through a stop or yield sign.

The relevance of the object, or group of objects, is given a higher value if the anticipation time period is shorter before the spatiotemporal trajectory of the ego vehicle must be altered. By way of example, a still distant vehicle that is approaching quickly may be regarded as more relevant than a vehicle that is approaching slowly.

In another particularly advantageous embodiment of the invention, the relevance of an object that is a vehicle changes when this vehicle is an autonomous driving vehicle, and/or networked vehicle. This change can be an increase or decrease in relevance, depending on the situation.

A self-driving vehicle is understood in particular to be a vehicle that moves autonomously in traffic, and is able to react automatically to other road users or obstructions. It may also be possible for a human driver to intervene. A vehicle that can be switched, partially or entirely, between a manual driving mode and an autonomous mode, is also regarded as self-driving when the driver is not exerting any control.

A networked vehicle is understood to be a vehicle in particular that has at least one communication interface, via which the actual intended or desired behavior of the vehicle in traffic, and/or information that is relevant to the behavior of other vehicles, can be communicated with regard to other vehicles or with regard to a traffic infrastructure.

It can normally be assumed, for example, that self-driving vehicles are programmed to behave in a manner complying with regulations, and in a cooperative manner. It therefore cannot be assumed that such a vehicle will intentionally violate the right of way. If however, other observations indicate that the control of the self-driving vehicle is malfunctioning, this vehicle may in fact be regarded as particularly relevant.

Furthermore, a networked vehicle can automatically communicate with the ego vehicle to indicate that both vehicles are driving synchronously at a short distance to one another in the same direction, coupled by an “electronic tow bar.” The other networked vehicle is then very close to the ego vehicle, and appears large in the window, but has no relevance to the safety of the ego vehicle. In contrast, a vehicle driven by a human, approaching inconspicuously from a side street may be very relevant. In this regard, the display on the display device represents an “augmented reality,” which corrects the intuitive impression of the relevance determined as such through an optical observation.

In another particularly advantageous embodiment of the invention, the object is identified with a first sensor system in the ego vehicle, and at least one second sensor system in the ego vehicle, which has a different contrast mechanism than the first sensor system, is used for evaluating its relevance. By way of example, a vehicle can be identified as an object in an optical overview image, and its speed can be subsequently determined with a radar sensor. In this manner, each sensor system can optimally make use of its specific qualities, and the sensor systems can also be at least partially checked against one another for plausibility. The two sensor systems do not necessarily have to belong to the same assistance system for this. Instead, numerous sensor systems belonging to different assistance systems can be interlinked for the purposes of the method, and the observations of these sensor systems can be pooled.

A sensor system is understood to be any assembly that outputs a signal that changes depending on the presence of objects within the detection range of the sensor system. A contrast mechanism is understood to be the physical interaction that proposes the change in the signal that indicates a bridge between the presence and absence of an object. As a result, objects in camera images form an optical contrast. Metallic objects generate a contrast in radar readings in that the reflect the radar waves.

In another particularly advantageous embodiment of the invention, the objects identified by numerous sensor systems belonging, e.g., to different assistance systems, and the relevance thereof determined by an assistance system coupled to the respective sensor system, are combined for the depiction. The combination can comprise, in particular, a unification of the objects identified by the numerous sensor systems, and/or the associated relevance.

In another particularly advantageous embodiment of the invention, one and the same object is identified by the sensor systems belonging to numerous assistance systems, and evaluated by the assistance systems with regard to its respective relevance, wherein the highest determined relevance for the depiction and the intervention, or the warning, is regarded as the basis. In this manner, not only the sensor systems present in the assistance system, but also the associated logic systems, can be bundled together for the evaluation.

According to the above, the invention can be embodied in particular in one or more assistance systems for an ego vehicle. The invention therefore relates to an assistance system as well. This assistance system is configured to monitor the environment of the ego vehicle with at least one sensor system. The assistance system comprises an identification logic system for identifying objects in the environment of the ego vehicle, and an evaluation logic system for evaluating the relevance of identified objects, and/or groups of identified objects, for the ego vehicle, and/or for its spatiotemporal trajectory. The assistance system is configured to depict the objects on at least one display device located in the ego vehicle. The assistance system also comprises at least one actuator for intervening in the spatiotemporal trajectory of the ego vehicle, and/or a warning device for issuing a corresponding maneuvering instruction to the driver of the ego vehicle. There is an intervention logic system that is configured to activate the actuator and/or the warning device when the relevance of the object exceeds an intervention threshold T2.

The sensor system and the display device can both be part of the assistance system, although this is not necessarily the case. An existing sensor system and/or display device in the ego vehicle can also be used. In particular, one and the same sensor system and/or one and the same display device can be used collectively by numerous assistance systems in the ego vehicle.

According to the invention, the assistance system also has a visualization logic that is configured to at least enhance the visual conspicuousness of an object on the display device when the relevance of the object exceeds a notification threshold T1, wherein the notification threshold T1 is lower than the intervention threshold T2.

As explained above, this ensures that the work of the assistance system is checked for plausibility by the driver. As a result, it should be the case that interventions or warnings by the assistance system no longer come as a surprise to the driver of the ego vehicle. All of the disclosures relating to the method also apply expressly to the assistance system and vice versa.

As explained above, the method can make use of sensor systems and logic systems for evaluation that are already present in an ego vehicle equipped with assistance systems. These existing sensor systems and logic systems can also be given a further use for the method. The hardware of the control units in the ego vehicle have more than sufficient capacity for executing the method. It is therefore conceivable to give the ego vehicle the functionality of the method solely through an implementation of the method in the form of a software. Such a software can be distributed, e.g., as an update, upgrade, or as a supplier product for an assistance system, and in this regard is an independent product. For this reason, the invention also relates to a computer program product with machine readable instructions that, when they are executed on a computer and/or on a control unit, upgrade the computer, and/or the control device, to a visualization logic of the assistance system according to the invention, and/or cause it to execute a method according to the invention.

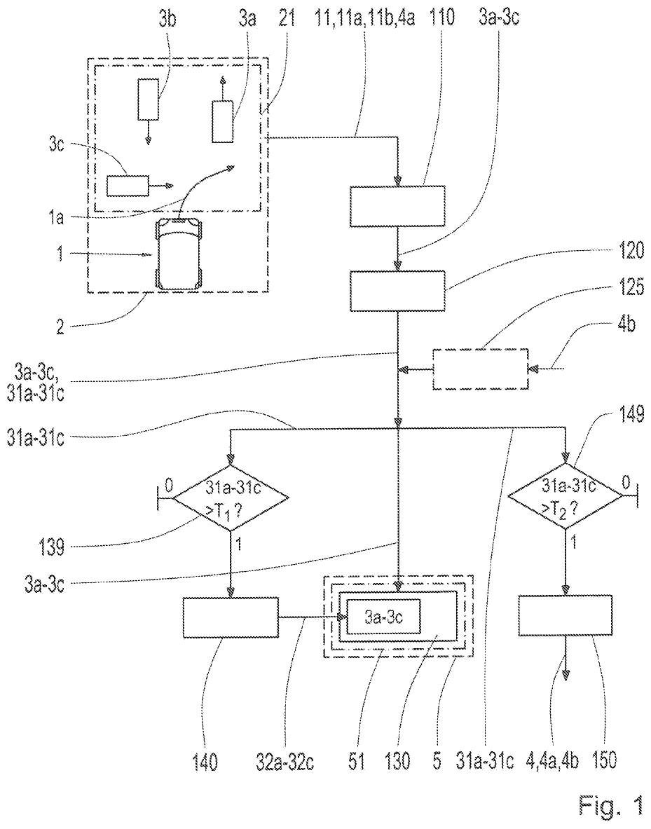

FIG. 1 illustrates the course of an exemplary embodiment of the method 100. The ego vehicle 1 is located in an environment 2. A region 21 of the environment 2 is observed by a sensor system 11, 1a, 11b of a first assistance system 4a. The intended spatiotemporal trajectory 1a of the ego vehicle 1 is indicated in FIG. 1.

There are three other vehicle 3a-3c in the region 21 of the environment 2, the current directions of movement of which are indicated by arrows. The vehicles 3a-3c are identified as objects in step 110 of the method 100. The relevance 31a-31c of the objects 3a-3c is evaluated in step 120 of the method 100. This relevance 31a-31c is optionally combined in step 125 with the relevance of other objects that have been identified by a second assistance system 4b, not explained in greater detail herein. The objects 3a-3c are depicted in step 130 in a depiction 51 that corresponds to the observed environment region 21 on the display device 5.

In block 139, it is checked whether the relevance 31a-31c of each object 3a-3c is greater than the notification threshold T1. If this is the case (logical value 1), then the visual conspicuousness 32a-32c with which the three objects 3a-3c are depicted on the display device 5 is enhanced in accordance with step 140.

Independently thereof, it is checked in block 149 whether the relevance 31a-31c of any of the objects 3a-3c is greater than the intervention threshold T2. If this is the case (logical value 1), then an intervention is made in the spatiotemporal trajectory 1a of the ego vehicle in accordance with step 150.

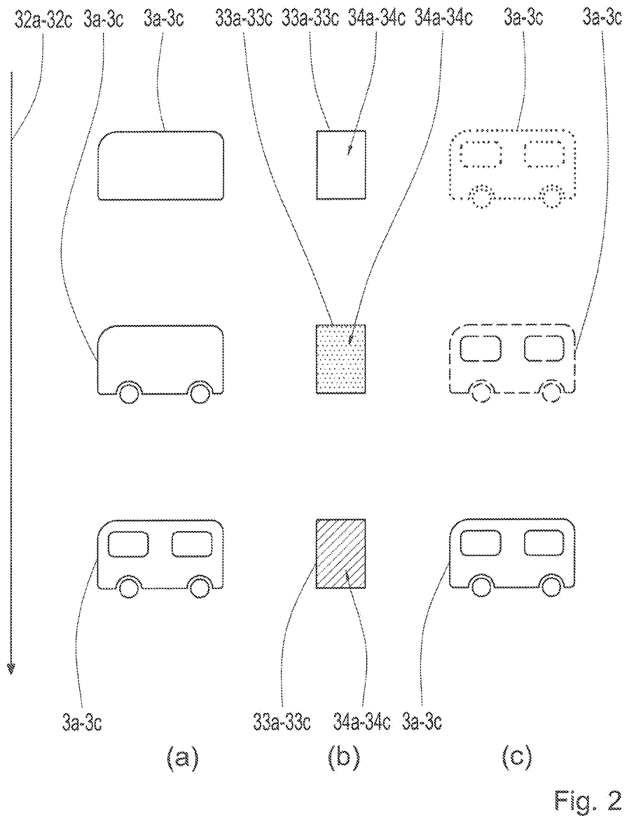

FIG. 2 shows, by way of example, various possibilities for who the visual conspicuousness 32a-32c of the objects 3a-3c can be enhanced in steps. The arrow in FIG. 2 indicates that the visual conspicuousness 32a-32c increased from top to bottom.

According to possibility (a), the depictions of the objects 3a-3c are abstracted in order to obtain a lower visual conspicuousness 32a-32c. If the intended visual conspicuousness 32a-32c is greater, more details are included, until the depiction reaches the highest visual conspicuousness 32a-32c, ultimately corresponding to the actual form of a vehicle.

According to possibility (b), the object 3a-3c is depicted as an outline 33a-33c. A surface 34a-34c of this outline 33a-33c has maximum transparency in the case of lower visual conspicuousness 32a-32c. Higher visual conspicuousness 32a-32c results in lower transparency of this surface 34a-34c.

According to possibility (c), the color in which the object 3a-3c is depicted is altered in order to change the visual conspicuousness. The colors are replaced in FIG. 2 by different shadings. With a lower visual conspicuousness 32a-32c, the selected color is paler, and with a higher visual conspicuousness 32a-32c, the selected color is more saturated and conspicuous.

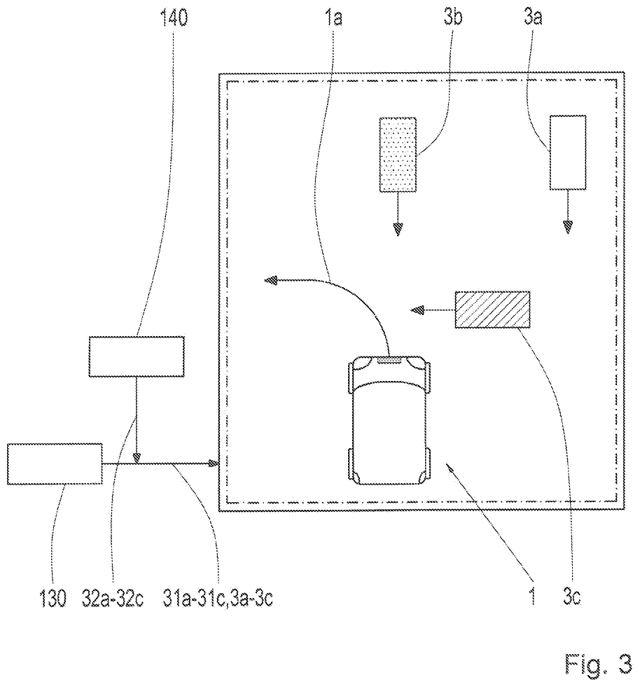

FIG. 3 shows, by way of example, a depiction 51 of the environment region 21 on the display device 5. The ego vehicle 1, the spatiotemporal trajectory 1a of the ego vehicle 1, and three objects 3a-3c are indicated in this depiction 51. The current directions of movement of the objects 3a-3c are indicated by arrows. The visual conspicuousness 32a-32c with which the objects 3a-3c are depicted is encoded in accordance with possibility (b) from FIG. 2.

The object 3a is on a course that does not intersect with the spatiotemporal trajectory 1a of the ego vehicle 1. Accordingly, it has a lower relevance 31a and is assigned a low visual conspicuousness 32a.

The object 3b is approaching the ego vehicle 1 from the front. According to the spatiotemporal trajectory 1a, the ego vehicle 1 intends, however, to turn left in front of the object 3b. Depending on the speeds of the ego vehicle 1 and the object 3b, this could result in a collision. For this reason, object 3b is assigned a medium relevance 31b, and is accordingly also assigned a medium visual conspicuousness 32b.

The object 3c is approaching the ego vehicle 1 from the right. The ego vehicle 1 will not avoid this object 3c with the intended left turn. If the spatiotemporal trajectory 1a of the ego vehicle 1 therefore remains unchanged, there is a high probability of a collision. Accordingly, the object 3c is assigned a greater relevance 31c and is given the highest visual conspicuousness 32c.

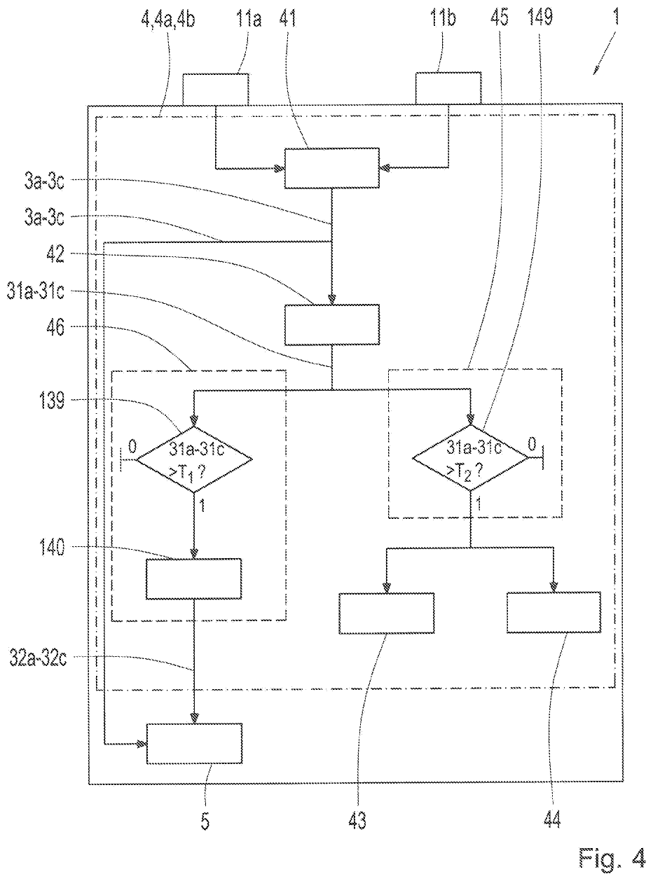

FIG. 4 shows, by way of example, an assistance system 4, 4a, 4b for use in an ego vehicle 1. The assistance system 4, 4a, 4b makes use of sensor systems 11a and 11b in the ego vehicle 1. The data from the sensor systems 11a and 11b are evaluated by the identification logic 41. The identification logic 41 identifies the objects 3a-3c and reports to the evaluation logic 42 and transmits this information to the display device 5. The evaluation logic 42 determines the relevance 31a-31c of the objects 3a-3c. This relevance 31a-31c is then checked in a block 139 within the visualization logic 46 to determine whether it exceeds the notification threshold T1. If this is the case (logical value 1), the visual conspicuousness 32a-32c of the object 3a-3c in question is enhanced in according with step 140 implemented in the visualization logic 46. The relevance 31a-31c is also checked in block 149 within the engagement logic to determine whether the intervention threshold T2 has been exceeded. If this is the case (logical value 1), the actuator 43 is activated in order to intervene in the spatiotemporal trajectory 1a of the ego vehicle 1. Alternatively or in combination therewith, the warning device 44 can be activated in order to issue an avoidance maneuvering instruction to the driver of the ego vehicle 1.

### REFERENCE SYMBOLS

1 ego vehicle
1a spatiotemporal trajectory of the ego vehicle 1
11, 11a, 11 b sensor system for the ego vehicle 1
2 environment of the ego vehicle 1
21 observed region of the environment 2
3a-3c objects
31a-31c relevance of the objects 3a-3c
32a-32c visual conspicuousness of the objects 3a-3c
33a-33c outlines of the objects 3a-3c
34a-34c surfaces of the outlines 33a-33c
4, 4a, 4b assistance system for the ego vehicle 1
41 identification logic for the assistance system 4, 4a, 4b
42 evaluation logic for the assistance system 4, 4a, 4b
43 actuator for the assistance system 4, 4a, 4b
44 warning device for the assistance system 4, 4a, 4b
45 intervention logic for the assistance system 4, 4a, 4b
46 visualization logic for the assistance system 4, 4a, 4b
5 display in ego vehicle 1
51 depiction in the display 5
100 method
110 identification of objects 3a-3c
120 determination of relevance 31a-31c of the objects 3a-3c
125 combining objects 3a-3c and relevance 31a-31c
130 depiction of the objects 3a-3c
139 checking whether the relevance 31a-31c>notification threshold T1
140 enhancing visual conspicuousness 32a-32c
149 checking whether the relevance 31a-31c>intervention threshold T2
150 intervention in trajectory 1a or warning to the driver
T1 notification threshold for relevance 31a-31c
T2 intervention threshold for relevance 31a-31c

1. A method for monitoring an environment of an ego vehicle, comprising:
identifying and evaluating at least one object in the environment of the ego vehicle with a sensor system, wherein the evaluation is based on the relevance for the ego vehicle, and/or for its intended spatiotemporal trajectory,
wherein, if the relevance exceeds an intervention threshold T2, an assistance system intervenes in the spatiotemporal trajectory of the ego vehicle, and/or the driver of the ego vehicle is issued a maneuvering suggestion in this regard, in order to prevent or mitigate a collision,
wherein the object, including its position in relation to the ego vehicle, is depicted on a display device in the ego vehicle,
wherein the visual conspicuousness of the object on the display device is at least enhanced when the relevance of the object exceeds a notification threshold T1, and
wherein the notification threshold T1 is lower than the intervention threshold T2.

2. The method according to claim 1, wherein the notification threshold T1 is determined such that the enhancement of the visual conspicuousness of the object takes place 0.3 seconds to 1 second before reaching the intervention threshold T2.

3. The method according to claim 1, wherein the object is depicted on the display device as soon as it is identified in an environment region outside the ego vehicle that corresponds to the depiction on the display device.

4. The method according to claim 1, wherein the visual conspicuousness of the object on the display device is enhanced continuously, or in numerous steps, as the relevance of the object increases.

5. The method according to claim 1, wherein the visual conspicuousness of the object is modified in that the depiction of the object is abstracted in order to obtain a lower visual conspicuousness, and is made more concrete in order to obtain a higher visual conspicuousness.

6. The method according to claim 1, wherein the object is depicted as an outline, wherein the transparency of a surface of the outline is increased in order to obtain a lower visual conspicuousness and reduced in order to obtain a higher visual conspicuousness.

7. The method according to claim 1, wherein the color in which the object is depicted is modified in order to alter the visual conspicuousness.

8. The method according to claim 1, wherein the relevance of the object is given a higher evaluation if the probability that the spatiotemporal trajectory of the ego vehicle must be altered is greater, in order to prevent or mitigate a collision with the object.

9. The method according to claim 1, wherein the relevance of the object is given a higher evaluation if an anticipated time period until the spatiotemporal trajectory of the ego vehicle must be altered is shorter.

10. The method according to claim 1, wherein the relevance of an object that is a vehicle is modified when this vehicle is a self-driving vehicle, and/or a networked vehicle.

11. The method according to claim 1, wherein the object is identified with a first sensor system in the ego vehicle and a least a second sensor system in the ego vehicle, wherein a contrast mechanism of the second sensor system differs from a contrast mechanism of the first sensor system, is used to evaluate its relevance.

12. The method according to claim 1, wherein the object identified by numerous sensor systems, and its relevance determined by an assistance system coupled to the respective sensor system, are combined for the visualization thereof.

13. The method according to claim 1, wherein one and the same object is identified by the sensor systems belonging to numerous assistance systems and evaluated by the assistance systems with regard to its respective relevance, wherein the highest determined relevance is the basis for the visualization and the intervention or warning.

14. An assistance system configured to monitor an environment of an ego vehicle, the assistance system comprising:
at least one sensor system, the at least one sensor system comprising an identification logic for identifying objects in the environment of the ego vehicle, an evaluation logic for evaluating the relevance of the identified object for the ego vehicle, and/or for its spatiotemporal trajectory;
a display device located in the ego vehicle and configured for depicting the object;
at least one actuator for intervening in the spatiotemporal trajectory of the ego vehicle to prevent or mitigate a collision with the object;
an intervention logic that is configured to activate the actuator when the relevance of the object exceeds an intervention threshold T2; and
a visualization logic that is configured to at least enhance the visual conspicuousness of an object on the display device when the relevance of the object exceeds a notification threshold T1, wherein the notification threshold T1 is lower than the intervention threshold T2.

15. (canceled)

16. An assistance system configured to monitor an environment of an ego vehicle, the assistance system comprising:
at least one sensor system, the at least one sensor system comprising an identification logic for identifying objects in the environment of the ego vehicle, an evaluation logic for evaluating the relevance of the identified object for the ego vehicle, and/or for its spatiotemporal trajectory;
a display device located in the ego vehicle and configured for depicting the object;
a warning device for issuing a corresponding maneuvering instruction to the driver of the ego vehicle, also comprising;
an intervention logic that is configured to activate the warning device when the relevance of the object exceeds an intervention threshold T2; and
a visualization logic that is configured to at least enhance the visual conspicuousness of an object on the display device when the relevance of the object exceeds a notification threshold T1, wherein the notification threshold T1 is lower than the intervention threshold T2.
